(19) United States
(12) Patent Application Publication
(10) Pub. No.: US 2022/0279800 A1
(43) Pub. Date: Sep. 8, 2022

(54) METHOD OF FORMING A TWISTED PRODUCT

(71) Applicant: RHEON AUTOMATIC MACHINERY CO., LTD., Tochigi (JP)

(72) Inventor: KAZUHIRO HARADA, Costa Mesa, CA (US)

(21) Appl. No.: 17/679,643

(22) Filed: Mar. 3, 2022

(30) Foreign Application Priority Data
Mar. 5, 2021 (JP) 2021-035266

(51) Int. Cl. A21C 3/08

(52) U.S. Cl. CPC A21C 3/08

(57) ABSTRACT

A method of forming a twisted product from elongated food materials comprises steps of continuously and downwardly discharging elongated food materials and at the same time twisting the elongated food materials around a vertical axis; conveying the elongated food materials by a conveyor in a lateral direction after the elongated food materials have reached the conveyer; narrowing a separating portion of a lowering region of the elongated food material by a shutter-type squeezing device; allowing the separating portion to become a thin connecting portion which can be separated by a pulling operation, and separating the thin connecting portion to form a twisted product.

### TECHNICAL FIELD

The present invention relates to a method of forming a twisted product, more specifically, to a method of forming a twisted product by continuously and downwardly discharging at least one elongated food material and at the same time twisting the elongated food material around a vertical axis.

### BACKGROUND ART

The Patent Publications 1 and 2 indicated later disclose a method and a system of forming a twisted product by continuously and downwardly discharging elongated food materials (for example, dough for sweets such as biscuits, cookies, etc. or fermented dough such as bread dough) and at the same time twisting the elongated food materials around a vertical axis. After the food materials have been discharged and twisted by a discharging device, the elongated food materials are conveyed by a conveyor in a lateral direction and cut in a predetermined length by a cutting device (a cutting blade or a shutter mechanism) to form a twisted product.

The Patent Publications 3 and 4 indicated later disclose a method and a system of forming a product by continuously and downwardly discharging an elongated food material. The elongated food material includes an inner material which is straightly and downwardly discharged without being twisted, and an outer material which is discharged so as to be spirally coiled around the inner material. Soon after the elongated food material is discharged by a discharging device, the elongated food material is cut in a predetermined length by a cutting device (a shutter mechanism) to form a product and then, the product is conveyed by a conveyor in a lateral direction.

### PRIOR ART PUBLICATION

Patent Publication 1: Japanese Utility Model Laid-open Publication No. S56-138584

Patent Publication 2: Japanese Patent Laid-open Publication No. 2005-269931

Patent Publication 3: Japanese Unexamined Utility Model No. 3062496

Patent Publication 4: Japanese Unexamined Utility Model No. 3057847

Patent Publication 5: Japanese Patent Laid-open Publication No. S62-166850

### SUMMARY OF THE INVENTION

### Problem to be Solved by the Invention

In the forming system described in the Patent Publication 2, if, instead of its cutting device (the shutter mechanism), the cutting device (shutter mechanism) described in the Patent Publication 3 or 4 is employed, it is expected that a compact forming system could be accomplished because the discharging device and the cutting device (the shutter mechanism) are disposed adjacent to each other.

However, although such a compact forming system was made experimentally, it was found that the elongated food materials could not be substantially twisted until they reached the conveyor. Further, an orientation of the cut elongated food materials was not stable when the elongated food materials landed on the conveyor. This means that the cut elongated food materials were not delivered to the following conveyor so that they cannot be arranged on a pan.

Thus, an object of the present invention is to provide a new method in which a forming system of twisted product from at least one elongated material can become compact even though a shutter mechanism is used, and in which an orientation of the elongated food material can become stable when the elongated food material lands on a conveyor.

### Means for Solving the Problem

In order to accomplish this object, a method of forming a twisted product from at least one elongated food material according to the present invention comprises continuously and downwardly discharging an at least one elongated food material and at the same time twisting the elongated food material around a vertical axis; conveying the elongated food material by a conveyor in a lateral direction after the elongated food material has reached the conveyer; narrowing a separating portion of a lowering region of the elongated food material by a shutter-type squeezing device; allowing the separating portion to become a thin connecting portion which can be separated by a pulling operation; and separating the thin connecting portion to form a twisted product.

According to this method, the at least one elongated food material is continuously and downwardly discharged and at the same time is twisted around the vertical axis, and then the separating portion of the lowering region of the elongated food material is narrowed by the shutter-type squeezing device. This allows a discharging unit for discharging the elongated food material and the shutter-type squeezing device to be disposed adjacent to each other. Thus, a system of forming the twisted product from the elongated food material can become compact even though a shutter mechanism is used. Further, the elongated food material is only narrowed by the shutter-type squeezing device without being cut. This allows a twisted configuration of the elongated food material to be maintained, and also allows an orientation of the elongated food material become stable when it lands on the conveyor. As a result, the elongated food material can be stably delivered to a following conveyor for arranging it on a pan, and thus, the twisted products can be arranged without disorder.

In an embodiment of the method according to the present invention, preferably, the conveyor includes a first conveyor receiving the elongated food material, and a second conveyor disposed downstream of the first conveyor, a speed of the second conveyor is faster than that of the first conveyor, and the thin connecting portion is separated by the speed difference between the first conveyor and the second conveyor.

In another embodiment of the method according to the present invention, preferably, the conveyor includes a first conveyor receiving the elongated food material, a second conveyor disposed downstream of the first conveyor, and the thin connecting portion is separated by a step between the first conveyor and the second conveyor.

In still another embodiment of the method according to the present invention, preferably, the thin connecting portion is separated by a separating device disposed at or downstream of the first conveyor.

### BRIEF DESCRIPTION OF THE DRAWINGS

FIG. 1 is a schematic view of an example of a forming system used for a method of forming a twisted product according to the present invention.

FIG. 2 is a schematic view of a rotational nozzle seen from its upside.

FIG. 3 is a schematic view of a shutter-type squeezing device in an opened position.

FIG. 4 is a schematic view of the shutter-type squeezing device in a partially-closed position with a clearance.

FIG. 5 is a schematic view showing a narrowed portion of the elongated food materials.

FIG. 6 is a schematic view showing the narrowed portion of the elongated food materials.

### DESCRIPTION OF PREFERRED EMBODIMENTS

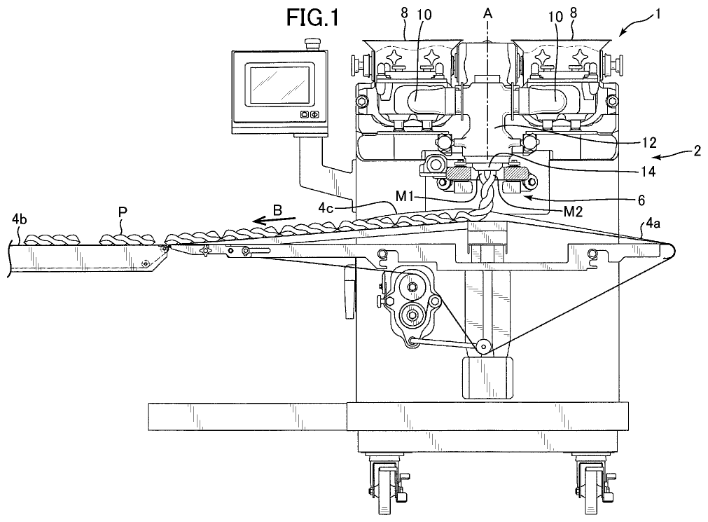

Referring to FIG. 1, an example of a forming system will be explained, which forming system is used for a method of forming a twisted product from at least one elongated food material according to the present invention. The forming system 1 forms a twisted product P from two elongated food materials M1, M2.

The forming system 1 has a discharging unit 2 by which the two elongated food materials M1, M2 are continuously and downwardly discharged and at the same time are twisted around a vertical axis A, a first conveyor 4a by which the discharged elongated food materials M1, M2 are conveyed in a lateral direction B, a second conveyor 4b disposed downstream of the first conveyor 4a, and a shutter-type squeezing device 6 by which a predetermined portion MP of the discharged elongated food materials M1, M2 is narrowed.

The discharging unit 2 has a structure which is similar to, for example, that of a discharging mechanism described in the Patent Publication 1. Briefly, the discharging unit 2 has two hoppers 8 into which the food materials M1, M2 are respectively thrown, two supplying sections 10 by which the food materials M1, M2 are supplied from the respective hoppers 8, a gathering section 12 by which the food materials M1, M2 are gathered, and a rotational nozzle 14 by which the gathered food materials M1, M2 are discharged and at the same time are rotated.

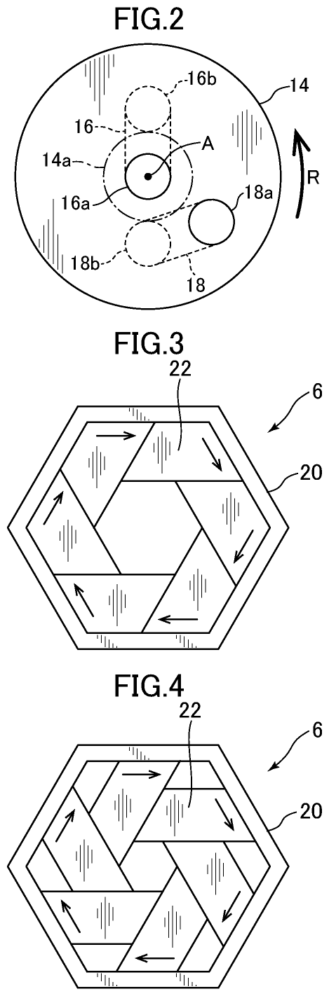

In the gathering section 12, the one food material M1 is disposed along the vertical axis A, while the other food material M2 is disposed annularly around the one food material M1. As shown in FIG. 2 seeing the rotational nozzle 14 from its upside, the rotational nozzle 14 is rotatable in a direction of an arrow R, and has two flow paths 16, 18. A boundary 14a drawn by a dashed-dotted line indicates a position of a partition between the one food material M1 and the other food material M2. The one path 16 is designated to the one food material M1 and has an inlet 16a disposed on the vertical axis A and an outlet 16b offset from the inlet 16a. The other path 18 has an inlet 18a disposed at the food material M2, and an outlet 18b disposed opposite to the outlet 16b with respect to the vertical axis A. Thus, the discharging unit 2 is configured so that the food materials M1, M2, which are supplied via the supplying sections 10 from the hoppers 8, are continuously and downwardly discharged through the outlets 16b, 18b of the flow paths 16, 18 as the two elongated food materials M1, M2. The discharging unit 2 is also configured so that the two elongated food materials M1, M2 are discharged and at the same time are twisted around the vertical axis A by rotating the rotational nozzle 14.

The first conveyor 4a may have a trough section 4c, which is configured so that its central area in its width direction is positioned lower than its side areas to dispose the two food materials M1, M2 at the central area in the width direction after they are received by the first conveyor 4a. Further, a speed of the second conveyor 4b is preferably faster than that of the first conveyor 4a.

The shutter-type squeezing device 6 has a structure which is similar to, for example, that of a shutter-type cutting mechanism described in the Patent Publication 5 etc. Briefly, as shown in FIGS. 3 and 4, the shutter-type squeezing device 6 has an outer frame 20, and six shutter pieces 22 accommodated in the outer frame 20. The squeezing device 6 is configured so that an opening defined by the six shutter pieces 22 can be opened and closed like a shutter of a camera. FIG. 3 shows an opened position of the shutter pieces 22 at which the opening is opened, and FIG. 4 shows a partially-closed position of the shutter pieces 22 at which the openings is almost closed but has a clearance. Namely, in the shutter-type squeezing device 6 according to the present invention, the shutter pieces 22 are moved from the opened position to the partially-closed position with the clearance to narrow the food materials M1, M2 without cutting them. Please note that in the cutting device described in the Patent Publication 5 etc., such shutter pieces are moved from an opened position to a fully-closed position to cut the food materials. In the shutter-type squeezing device 6 according to the present embodiment, preferably, the partially-closed position can be adjusted so that a size of the opening or the clearance in the partially-closed position can be adjusted. The shutter-type squeezing device 6 is not limited to a slide-type shutters as described in the Patent Publication 5, but the squeezing device 6 may employ any type of shutters including swing-type shutters.

Next, an embodiment of a method of forming a twisted product from at least one elongated food material according to the present invention will be explained. The food material is fermented bread dough and has a viscoelastic character.

The two elongated food materials M1, M2 are continuously and downwardly discharged (discharging operation) and at the same time are twisted around the vertical axis A (twisting operation). Soon after the discharging operation is started, the two elongated food materials M1, M2 are in a hanging state because the elongated food materials M1, M2 have not reached the first conveyor 4a. This means that the elongated food materials M1, M2 are not substantially in a mutually-twisted configuration. Namely, even if the elongated food materials M1, M2 are twisted, they would tend to be untwisted due to the elastic character of the bread dough. After the two elongated food materials M1, M2 have reached the first conveyor 4a, the mutually-twisted configuration of the two elongated food materials M1, M2 can be maintained, or are prevented from being untwisted.

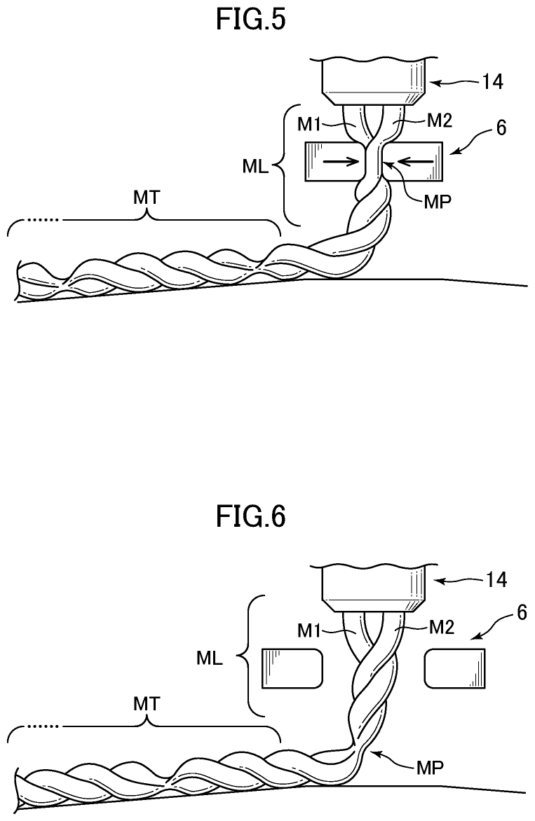

As shown in FIG. 1, the two elongated food materials M1, M2, which have reached the first conveyor 4a, are conveyed by the first conveyor 4a in the lateral or conveyed direction B. The two elongated food materials M1, M2 are regulated to the central area in the width direction of the first conveyor 4a by the trough section 4c. As shown in FIG. 5, the two elongated food materials M1, M2 include a lowering region ML between the rotational nozzle 14 and the first conveyor 4a, and a conveyed region MT which is being conveyed on the first conveyor 4a.

The predetermined portion MP in the lowering region ML of the two elongated food materials M1, M2 is narrowed or reduced in diameter by the shutter-type squeezing device 6. This narrowed portion MP is also a separating portion MP at which the elongated food materials M1, M2 are to be separated later. A degree of reducing the diameter can be adjusted by varying the partially-closed position of the shutter pieces 22. Reducing the diameter causes an effect that an outer layer of the narrowed portion MP can be pulled inwardly while the mutually-twisted configuration is maintained, and also causes an effect that the two elongated food materials M1, M2 are bonded with each other. If the portion MP was cut as described in the Patent Publications 3 and 4, the two elongated food materials M1, M2 would have returned to the hanging state, namely, would not have been substantially in the mutually-twisted configuration.

An untwisting force of the narrowed portion MP has been weakened. Thus, as shown in FIG. 6, until the narrowed portion MP reach the first conveyor 4a, an effect of the twisting operation by the rotational nozzle 14 is maintained in the elongated food materials M1, M2. At the same time, the diameter of the narrowed portion MP is further reduced due to the effect of the twisting operation.

Also, the two elongated food materials M1, M2 between the narrowed portion MP and the next narrowed portion MP tend to be shorten in their longitudinal direction (or the conveyed direction B) due to their elastic character. This allows that during conveying the two elongated food materials M1, M2, the narrowed portion MP to be pulled in the longitudinal direction B so that the narrowed portion MP is further narrowed. Finally, the narrowed portion MP becomes a thin connecting portion which is separated by pulling it. Preferably, the thin connecting portion has little elastic character, and for example, can be easily separated by pulling it by one's hands.

Next, the thin connecting portion MP is separated. In the present embodiment, the thin connecting portion MP is pulled between the first conveyor and the second conveyor by using a speed difference between the first conveyor 4a and the second conveyor 4b to separate it.

In this way, since the discharging unit 2 and the shutter-type squeezing device 6 are disposed adjacent to each other, the system of forming the twisted product from the elongated food materials can be made compact. Further, since the two elongated food materials M1, M2 are merely narrowed by the shutter-type squeezing device 6 without being cut, the effect of the twisting operation applied to the two elongated food materials M1, M2 can be maintained, and an orientation of the two elongated food materials M1, M2 when they land on the first conveyor 4a can become stable. As a result, an operation of delivering the two elongated food materials M1, M2 to a following conveyor for arranging the twisted products on a pan can become stable so that the twisted products can be arranged without disorder.

In the above-stated embodiment, the twisted product is formed from the two elongated food materials, but it may be formed from one elongated food material or more than two elongated food materials. Further, any cross-sectional shapes of the elongated food material can be employed, such as a circular shape, a polygonal (triangle, rectangular, or square) shape, and a starlike shape. Further, the elongated food material may have a multi-layer structure including an inner core and an outer cylindrical layer, as described in the Patent Publication 2.

In the above-stated embodiment, the elongated food materials are bread dough which is an example of fermented dough, but any food materials can be used, for example, another fermented dough, such as dough for a Chinese bun, another dough for pasta or noodles, another dough for sweets, such as biscuits and cookies, another dough for a pasted product, and another composite food material in which an outer material covers an inner material.

Since a material character such as an elastic character is different depending on a food material (such as dough), the partially-closed position of the shutter pieces 22 may be adjusted so that the narrowed portion MP can become the thin connecting portion which can be separated by pulling it. For example, in a food material with a larger elastic character, the clearance in the partially-closed position of the shutter pieces 22 is preferably set smaller than that in a food material with a smaller elastic character. Further, when the portion MP is narrowed by the shutter-type squeezing device 6, the diameter of the portion MP may become a diameter substantially the same as or more than that of the thin connecting portion, the latter being described in the above-state embodiment.

In the above-stated embodiment, the portion MP is separated by using the speed difference between the first conveyor 4a and the second conveyor 4b, but a step between the first conveyor 4a and the second conveyor 4b (different height levels of these conveyers 4a, 4b) or any other ways may be used to pull and separate the portion MP. Further, in order to surely separate the portion MP, an auxiliary separating device (such as a cutting blade) may be provided at the first conveyor 4a or its downstream.

What is claimed:

1. A method of forming a twisted product from at least one elongated food material, comprising steps of:
continuously and downwardly discharging an at least one elongated food material and at the same time twisting the elongated food material around a vertical axis;
conveying the elongated food material by a conveyor in a lateral direction after the elongated food material has reached the conveyer;
narrowing a separating portion of a lowering region of the elongated food material by a shutter-type squeezing device;
allowing the separating portion to become a thin connecting portion which can be separated by a pulling operation; and
separating the thin connecting portion to form a twisted product.

2. The method according to claim 1,
wherein the conveyor includes a first conveyor receiving the elongated food material, and a second conveyor disposed downstream of the first conveyor,
wherein a speed of the second conveyor is faster than that of the first conveyor, and
wherein the thin connecting portion is separated by the speed difference between the first conveyor and the second conveyor.

3. The method according to claim 1,
wherein the conveyor includes a first conveyor receiving the elongated food material, and a second conveyor disposed downstream of the first conveyor, and
wherein the thin connecting portion is separated by a step between the first conveyor and the second conveyor.

4. The method according to claim 1, wherein the thin connecting portion is separated by a separating device disposed at or downstream of the first conveyor.
